(19) United States
(12) Patent Application Publication
(10) Pub. No.: US 2015/0023153 A1
(43) Pub. Date: Jan. 22, 2015

(54) COMMUNICATION CONTROL METHOD, HOME BASE STATION, AND CORE NETWORK DEVICE

(71) Applicant: KYOCERA CORPORATION, Kyoto-shi, Kyoto (JP)

(72) Inventor: Susumu Kashiwase, Machida-shi (JP)

(73) Assignee: KYOCERA CORPORATION, Kyoto-shi, Kyoto (JP)

(21) Appl. No.: 14/384,706

(22) PCT Filed: Mar. 12, 2013
(86) PCT No.: PCT/JP2013/056834

§ 371 Date: Sep. 12, 2014

Related U.S. Application Data
(60) Provisional application No. 61/611,987, filed on Mar. 16, 2012.

(51) Int. Cl. H04L 12/24; H04W 88/16; H04W 88/08; H04W 76/02; H04W 76/06

(52) U.S. Cl. CPC H04L 41/0668; H04W 76/02; H04W 76/06; H04W 88/08; H04W 88/16
USPC 370/221

(57) ABSTRACT

A communication control method applicable to a mobile communication system provided with a first gateway device, which manages a home base station, on a first communication path between a core network device and the home base station, comprises: an establishment step of establishing, between the core network device and the home base station, a second communication path without passing through the first gateway device and passing through a second gateway device, in the case of switching to the second gateway device for managing the home base station in place of the first gateway device.

### TECHNICAL FIELD

The present invention relates to a communication control method, a home base station, and a core network device in a mobile communication system.

### BACKGROUND ART

In 3GPP (3rd Generation Partnership Project), which is a project aiming to standardize a mobile communication system, specifications of a home base station, which is a small base station provided in a home or a company, and those of a gateway device that manages a plurality of home base stations are discussed (see Non-patent Document 1).

Such a gateway device can manage a subordinate home base station in place of a device provided in a core network (a core network device), and therefore, the load on a core network can be reduced.

### PRIOR ART DOCUMENT

### Non-Patent Document

Non-patent Document 1: 3GPP technical specification “TS 36.300 V11.0.0” December, 2011

### SUMMARY OF THE INVENTION

For example, there may be a case where it is preferred to stop the gateway device due to reasons such as a problem or failure in the gateway device.

However, according to current specifications, there is a problem that such a case is not considered.

Thus, an object of the present invention is to provide a communication control method, a home base station, and a core network device, with which it is possible to appropriately handle a case where a gateway device is to be stopped.

A communication control method according to the present invention is applied to a mobile communication system. The method comprises: a switching step of switching, from a first gateway device which is located on a first communication path between a core network device and a home base station and which manages the home base station, to a second gateway device for managing the home base station in place of the first gateway device. The switching step comprises: an establishment step of establishing, between the core network device and the home base station, a second communication path which passes through the second gateway device and which does not pass through the first gateway device.

The communication control method may further comprises: a determination step of determining, by the core network device or the home base station, a switching from the first gateway device to the second gateway device, on the basis of an operating status of the first gateway device.

The establishment step may comprise: a step of establishing a transitional communication path which passes through both the first gateway device and the second gateway device, while maintaining a part of the first communication path; and a step of establishing the second communication path, while maintaining a part of the transitional communication path.

The switching step may comprise: a disconnection step of disconnecting the first communication path, before establishing the second communication path in the establishment step.

The switching step may comprise: a disconnection step of disconnecting the first communication path, after establishing the second communication path in the establishment step.

A home base station according to the present invention is applied to a mobile communication system. The station comprises: a communication unit that communicates with a core network device using a first communication path which passes through a first gateway device; and a control unit that controls to establish, between the core network device and the home base station, a second communication path which passes through a second gateway device and which does not pass through the first gateway device, in a case of switching to the second gateway device for managing the home base station in place of the first gateway device.

A core network device according to the present invention is applied to a mobile communication system. The device comprises: a communication unit that communicates with a home base station using a first communication path which passes through a first gateway device; and a control unit that controls to establish, between the core network device and the home base station, a second communication path which passes through a second gateway device and which does not pass through the first gateway device, in a case of switching to the second gateway device for managing the home base station in place of the first gateway device.

### BRIEF DESCRIPTION OF THE DRAWINGS

FIG. 1 is a configuration diagram of a mobile communication system.

FIG. 2 is a protocol stack diagram of a user plane related to an S1 interface.

FIG. 3 is a protocol stack diagram of a control plane related to the S1 interface.

FIG. 4 is a block diagram of UE.

FIG. 5 is a block diagram of MeNB.

FIG. 6 is a block diagram of MME.

FIG. 7 is a block diagram of HeNB.

FIG. 8 is a block diagram of HeNB GW.

FIG. 9 is a diagram for explaining an operation pattern 1.

FIG. 10 is a sequence diagram of a specific example 1 of the operation pattern 1.

FIG. 11 is a sequence diagram of a specific example 2 of the operation pattern 1.

FIG. 12 is a diagram illustrating a specific example of a format of various messages.

FIG. 13 is a diagram for explaining an operation pattern 2.

FIG. 14 is a sequence diagram of a specific example 1 of the operation pattern 2.

FIG. 15 is a sequence diagram of a specific example 2 of the operation pattern 2.

FIG. 16 is a diagram for explaining an operation pattern 3.

### DESCRIPTION OF THE EMBODIMENTS

### Overview of the Embodiments

A communication control method according to the embodiments comprises: a switching step of switching, from a first gateway device which is located on a first communication path between a core network device and a home base station and which manages the home base station, to a second gateway device for managing the home base station in place of the first gateway device. The switching step comprises: an establishment step of establishing, between the core network device and the home base station, a second communication path which passes through the second gateway device and which does not pass through the first gateway device.

Thus, in a case where it is preferred to stop a first gateway device due to reasons such as a problem or failure in the first gateway device, a second communication path without passing through the first gateway device and passing through a second gateway device is established between a core network device and a home base station because of which the second gateway device can manage the home base station in place of the first gateway device. Therefore, it is possible to appropriately handle a case where a gateway device is to be stopped.

### Embodiments

In the present embodiment, an example of a mobile communication system configured on the basis of 3GPP standards (that is, LTE-Advanced) after release 10 will be described.

Hereinafter, (1) Overview of mobile communication system, (2) Block configuration, (3) Operation, and (4) Conclusion of embodiment will be sequentially described.

(1) Overview of Mobile Communication System

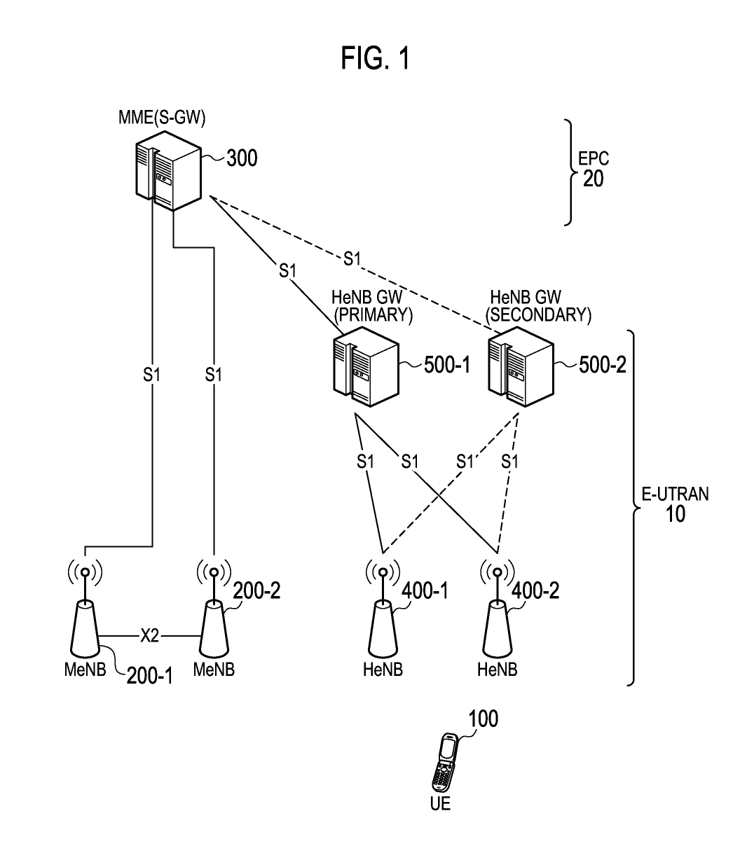

FIG. 1 is a configuration diagram of a mobile communication system according to the present embodiment. As illustrated in FIG. 1, the mobile communication system includes a user terminal (UE: User Equipment) 100, a macro base station (MeNB: Macro evolved Node-B) 200, a mobility management device (MME: Mobility Management Entity) 300, a home base station (HeNB: Home evolved Node-B) 400, and a gateway device (HeNB GW: Home evolved Node-B Gateway) 500.

Each of the MeNB 200, the HeNB 400, and the HeNB GW 500 is a network device included in a radio access network (E-UTRAN: Evolved-UMTS Terrestrial Radio Access Network) 10. The MME 300 is a network device included in a core network (EPC: Evolved Packet Core) 20. It must be noted that the EPC 20 includes a serving gateway device (S-GW: Serving Gateway), which is a network device operating in cooperation with the MME 300.

The UE 100 is a mobile radio communication device carried by a user. The UE 100 performs radio communication with a cell (called a “serving cell”), with which a connection is established, in a connected state corresponding to a state during communication. In an upper layer, the UE 100 communicates with the MME 300 (and the S-GW).

The MeNB 200 is a large stationary radio communication device installed by an operator. The MeNB 200 forms one macro cell or a plurality of macro cells. The MeNB 200 performs radio communication with the UE 100. Furthermore, the MeNB 200 communicates with the EPC 20 through an S1 interface that is a logical communication path between the MeNB 200 and the EPC 20. Specifically, the MeNB 200 communicates with the MME 300 through an S1-MME interface which is a kind of the S1 interface. Moreover, the MeNB 200 performs inter-base station communication with an adjacent MeNB 200 through an X2 interface that is a logical communication path between the MeNB 200 and the adjacent MeNB 200.

The MME 300 is provided corresponding to a control plane dealing with control information, and performs various types of mobility management or verification processes for the UE 100. The S-GW is provided corresponding to a user plane dealing with user data, and performs forwarding control and the like of user data.

The HeNB 400 is a small stationary radio communication device installable within the house. The MeNB 200 forms a specific cell having a coverage narrower than that of a macro cell. The specific cell is called a “CSG (Closed Subscriber Group) cell”, a “hybrid cell”, or an “open cell” according to a set access mode.

The CSG cell is a cell accessible only by UE 100 (called a “member UE”) having an access permission, and broadcasts CSG ID. The UE 100 holds a list (called a “white list”) of CSG ID for which the UE 100 has an access permission, and determines the presence or absence of access permission on the basis of the white list, and the CSG ID broadcasted by the CSG cell.

The hybrid cell is a cell in which the member UE is more advantageously treated as compared with a non-member UE, and broadcasts information, which indicates that the hybrid cell is a cell released to the non-member UE, in addition to the CSG ID. The UE 100 determines the presence or absence of access permission on the basis of the white list, and the CSG ID broadcasted by the hybrid cell.

The open cell is a cell in which the UE 100 is equivalently treated regardless of whether the UE 100 is a member, and does not broadcast the CSG ID. In view of the UE 100, the open cell is equal to a macro cell.

The HeNB 400 communicates with the HeNB GW 500 through the S1 interface (the S1-MME interface). However, when the S1 interface without passing through the HeNB GW 500 is established between the HeNB 400 and the MME 300, the HeNB 400 is able to directly communicate with the MME 300, without undergoing the HeNB GW 500.

The HeNB GW 500 manages a set of a plurality of HeNBs 400 between the EPC 20 (the MME 300) and the plurality of HeNBs 400. In view of the MME 300, the HeNB GW 500 is equal to the HeNB 400. On the other hand, in view of the HeNB 400, the HeNB GW 500 is equal to the MME 300. The HeNB GW 500 communicates with the MME 300 as a representative of the plurality of HeNBs 400, thereby reducing traffic to be transmitted to/received from the MME 300. Furthermore, the HeNB GW 500 is able to relay data from one HeNB 400 in the control of the HeNB GW 500 to another HeNB 400.

The E-UTRAN 10 includes HeNB GW 500-1 (a first gateway device) that is used as primary, and HeNB GW 500-2 (a second gateway device) that is used as secondary. The HeNB GW 500-2 is used to manage the HeNB 400 in place of the HeNB GW 500-1.

The HeNB GW 500-1 is provided on a first communication path between the MME 300 and the HeNB 400. In the case of switching to the HeNB GW 500-2 for managing the HeNB 400 in place of the HeNB GW 500-1, a second communication path without passing through the HeNB GW 500-1 and passing through the HeNB GW 500-2 is established between the MME 300 and the HeNB 400.

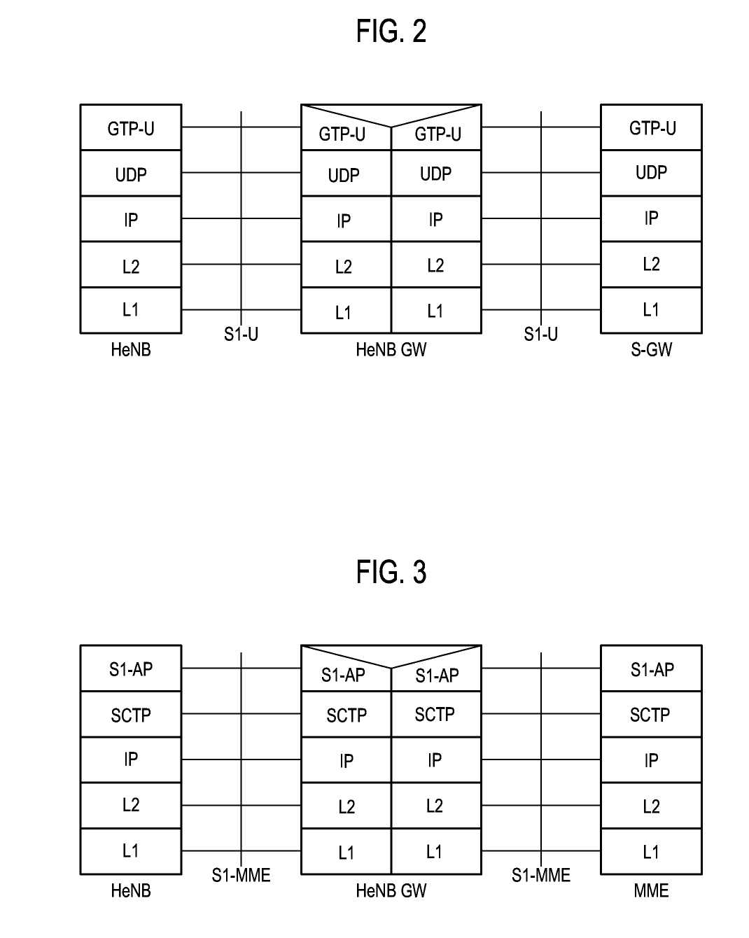

FIG. 2 and FIG. 3 are protocol stack diagrams for explaining a communication path established between the MME 300 and the HeNB 400.

As illustrated in FIG. 2, as regards the user plane, an IP (Internet Protocol) and a UDP (User Datagram. Protocol) are provided on a layer 1 (L1) and a layer 2 (L2), and a GTP (GPRS Tunneling Protocol)-U is provided on the UDP. The S1 interface in the user plane is referred to as “S1-U”.

As illustrated in FIG. 3, as regards the control plane, an IP and an SCTP (Stream Control Transmission Protocol) are provided on the L1 and the L2, and an S1-AP (S1 Application Protocol) is provided on the SCTP. The S1 interface in the control plane is referred to as “S1-MME”.

Hereinafter, the term “S1 interface” shall include both the S1-U and the S1-MME.

(2) Block Configuration

Hereinafter, the block configurations of the UE 100, the MeNB 200, the MME 300, the HeNB 400, and the HeNB GW 500 will be described.

(2.1) UE

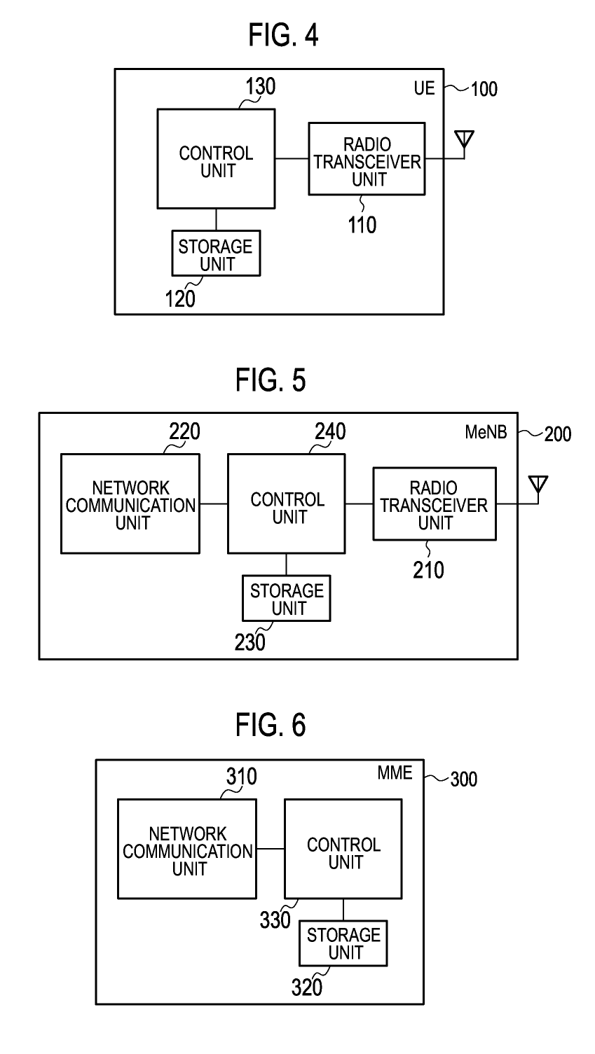

FIG. 4 is a block diagram of the UE 100. As illustrated in FIG. 4, the UE 100 includes a radio transceiver unit 110, a storage unit 120, and a control unit 130.

The radio transceiver unit 110 transmits/receives a radio signal.

The storage unit 120 stores various types of information that is used for the control by the control unit 130.The storage unit 120 stores a white list.

The control unit 130 controls various functions of the UE 100. In a connected state, the control unit 130 controls the radio transceiver unit 110 to perform radio communication with a serving cell.

In a connected state, when a CSG cell or a hybrid cell for which an access permission is available is detected on the basis of the CSG ID received from the CSG cell or the hybrid cell, and the white list, the control unit 130 performs the control for establishing a connection with the cell.

In a connected state, the control unit 130 communicates with the MME 300 (and the S-GW) through the serving cell.

(2.2) MeNB

FIG. 5 is a block diagram of the MeNB 200. As illustrated in FIG. 5, the MeNB 200 includes a radio transceiver unit 210, a network communication unit 220, a storage unit 230, and a control unit 240.

The radio transceiver unit 210 transmits/receives a radio signal. Furthermore, the radio transceiver unit 210 forms one macro cell or a plurality of macro cells.

The network communication unit 220 performs inter-base station communication with another MeNB through the X2 interface. The network communication unit 220 communicates with the MME 300 through the S1 interface.

The storage unit 230 stores various types of information that is used for the control by the control unit 240. The control unit 240 controls various functions of the MeNB 200.

(2.3) MME

FIG. 6 is a block diagram of the MME 300. As illustrated in FIG. 6, the MME 300 includes a network communication unit 310, a storage unit 320, and a control unit 330.

The network communication unit 310 communicates with the MeNB 200 and the HeNB GW 500 through the S1 interface.

The storage unit 320 stores various types of information that is used for the control by the control unit 330.

The control unit 330 controls various functions of the MME 300. In the case of switching to the HeNB GW 500-2 for managing the HeNB 400 in place of the HeNB GW 500-1, the control unit 330 can perform a control to establish a second communication path without passing through the HeNB GW 500-1 and passing through the HeNB GW 500-2, between the MME 300 and the HeNB 400.

(2.4) HeNB

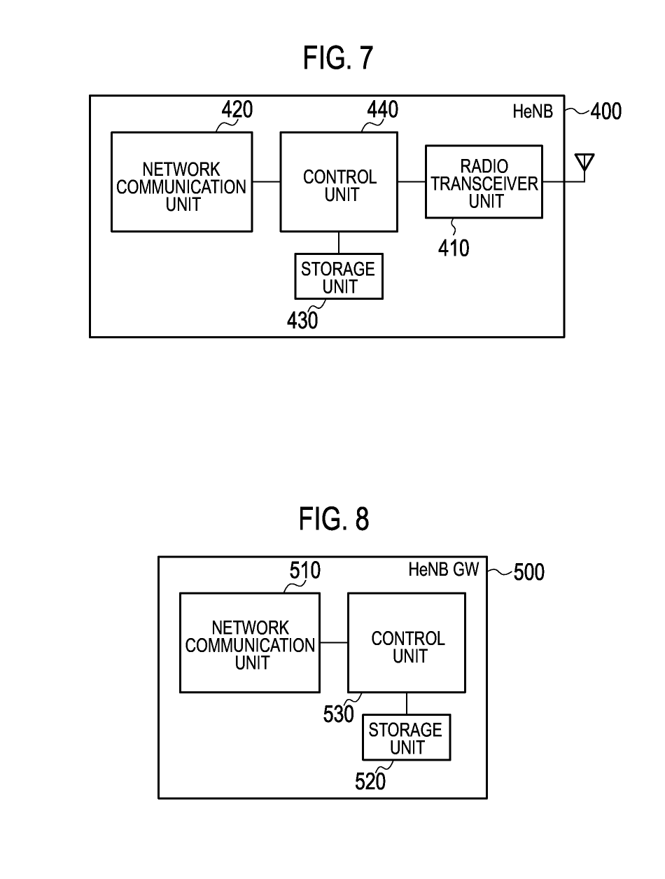

FIG. 7 is a block diagram of the HeNB 400. As illustrated in FIG. 7, the HeNB 400 includes a radio transceiver unit 410, a network communication unit 420, a storage unit 430, and a control unit 440.

The radio transceiver unit 410 transmits/receives a radio signal. Furthermore, the radio transceiver unit 410 forms a CSG cell, a hybrid cell, or an open cell.

The network communication unit 420 communicates with the HeNB GW 500 through the S1 interface.

The storage unit 430 stores various types of information that is used for the control by the control unit 440.

The control unit 440 controls various functions of the HeNB 400. In the case of switching to the HeNB GW 500-2 for managing the HeNB 400 in place of the HeNB GW 500-1, the control unit 440 can perform a control to establish a second communication path without passing through the HeNB GW 500-1 and passing through the HeNB GW 500-2, between the MME 300 and the HeNB 400.

(2.5) HeNB GW

FIG. 8 is a block diagram of the HeNB GW 500. As illustrated in FIG. 8, the HeNB GW 500 includes a network communication unit 510, a storage unit 520, and a control unit 530.

The network communication unit 510 communicates with the MME 300 and the HeNB 400 through the S1 interface.

The storage unit 520 stores various types of information that is used for the control by the control unit 530. In the storage unit 520, the HeNB 400 in the control of the HeNB GW 500 (that is, the HeNB 400 having an S1 connection with the HeNB GW 500) is registered.

The control unit 530 controls various functions of the HeNB GW 500. The control unit 530 manages a set of a plurality of HeNBs 400. The control unit 530 controls the network communication unit 510 to communicate with the MME 300 as a representative of the plurality of HeNBs 400.

(3) Operation

Hereinafter, an operation of the mobile communication system according to the present embodiment will be described in the order of an operation pattern 1 through an operation pattern 3.

(3.1) Operation Pattern 1

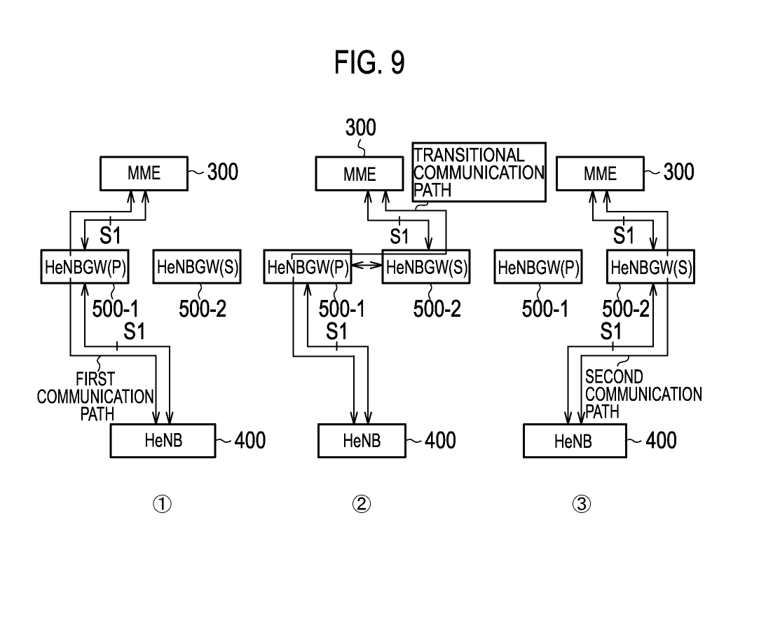

FIG. 9 is a diagram for explaining the operation pattern 1.

As illustrated in FIG. 9, firstly, a first communication path passing through the HeNB GW 500-1 is established between the MME 300 and the HeNB 400. The UE 100 that is connected to the HeNB 400 communicates with the MME 300 using the first communication path.

On the basis of the operating status of the HeNB GW 500-1, the MME 300 or the HeNB 400 determines switching from the HeNB GW 500-1 to the HeNB GW 500-2. For example, upon measuring the communication characteristic in the communication using the first communication path, and detecting a problem in the HeNB GW 500-1 on the basis of the measurement result, the MME 300 or the HeNB 400 determines the switching. If the throughput in the communication using the first communication path is lower than a threshold value, or the response time in the communication has exceeded the threshold value, it can be decided that a problem has occurred in the HeNB GW 500-1.

Once switching from the HeNB GW 500-1 to the HeNB GW 500-2 is determined, the process of switching to the HeNB GW 500-2 starts.

Secondly, while maintaining a part of the first communication path, a transitional communication path passing through both the HeNB GW 500-1 and the HeNB GW 500-2 is established between the MME 300 and the HeNB 400. Specifically, while maintaining the S1 interface between the HeNB 400 and the HeNB GW 500-1, a new S1 interface is established between the MME 300 and the HeNB GW 500-2, and a tunneling connection is established between the HeNB GW 500-1 and the HeNB GW 500-2. Furthermore, the S1 interface between the MME 300 and the HeNB GW 500-1 is disconnected.

Hereinafter, an example of establishing a transitional communication path while maintaining the S1 interface between the HeNB 400 and the HeNB GW 500-1 in the first communication path will be explained. However, the transitional communication path may be established as described below. Specifically, while maintaining the S1 interface between the MME 300 and the HeNB GW 500-1, a new S1 interface is established between the HeNB 400 and the HeNB GW 500-2, and a tunneling connection is established between the HeNB GW 500-1 and the HeNB GW 500-2. Furthermore, the S1 interface between the HeNB 400 and the HeNB GW 500-1 is disconnected.

Thirdly, while maintaining a part of the transitional communication path, a second communication path without passing through the HeNB GW 500-1, and passing through the HeNB GW 500-2 is established between the MME 300 and the HeNB 400. Specifically, while maintaining the S1 interface between the MME 300 and the HeNB GW 500-2, a new S1 interface is established between the HeNB 400 and the HeNB GW 500-2. Furthermore, the tunneling connection is disconnected.

Thus, in the operation pattern 1, after establishing the transitional communication path passing through both the HeNB GW 500-1 and the HeNB GW 500-2 while maintaining a part of the first communication path, the second communication path is established while maintaining a part of the transitional communication path. Accordingly, switching from the HeNB GW 500-1 to the HeNB GW 500-2 can be performed without interrupting the communication path between the HeNB 400 and the MME 300.

Next, specific examples 1 and 2 of the operation pattern 1 will be described. In the specific example 1, switching from the HeNB GW 500-1 to the HeNB GW 500-2 is led by the MME 300. In contrast, the switching is led by the HeNB 400.

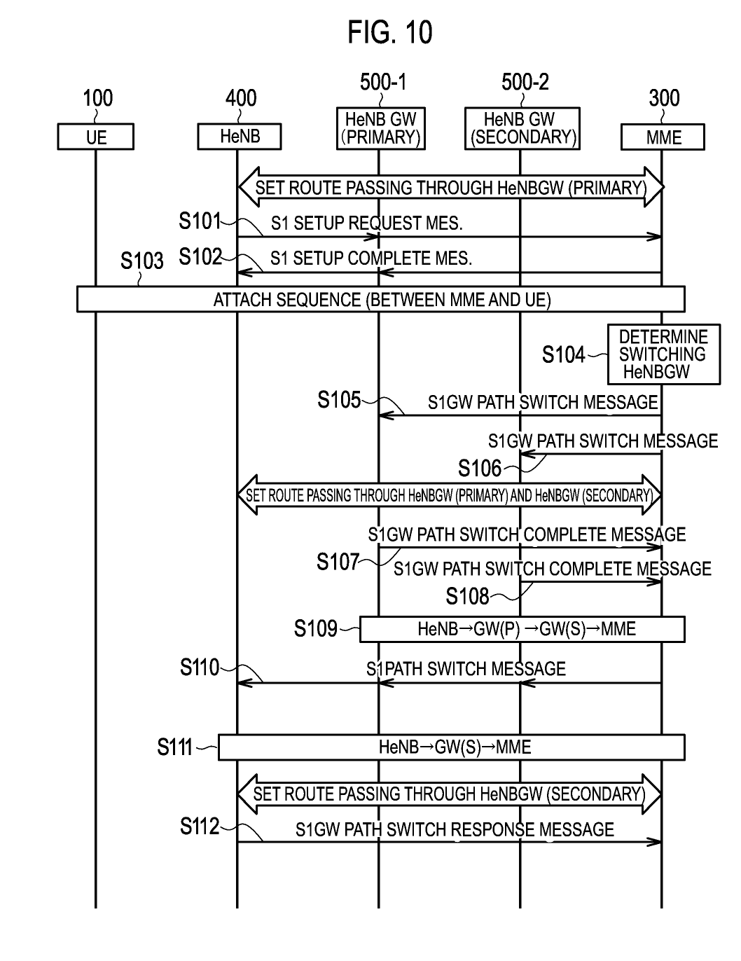

FIG. 10 is a sequence diagram of the specific example 1 of the operation pattern 1. The sequence illustrates the operation of establishing the first communication path through the operation of establishing the second communication path.

As illustrated in FIG. 10, in step S101, the HeNB 400 transmits an S1 Setup Request message for requesting the establishment of an S1 interface between the HeNB 400 and the HeNB GW 500-1, to the HeNB 500-1. In response to the S1 Setup Request message from the HeNB 400, the HeNB GW 500-1 starts the process of establishing an S1 interface between the HeNB GW 500-1 and the HeNB 400, and at the same time, transmits an S1 Setup Request message for requesting the establishment of an S1 interface between the HeNB GW 500-1 and the MME 300, to the MME 300. In response to the S1 Setup Request message, the MME 300 starts the process of establishing an S1 interface between the MME 300 and the HeNB GW 500-1.

In step S102, the MME 300 transmits an S1 Setup Complete message indicating the completion of establishment of the S1 interface between the MME 300 and the HeNB GW 500-1, to the HeNB GW 500-1. The HeNB GW 500-1 transmits an S1 Setup Complete message indicating the completion of establishment of the S1 interface between the HeNB GW 500-1 and the HeNB 400, to the HeNB 400.

Thus, the first communication path is established. Hereinafter, an operation for establishing the transitional communication path will be described.

In step S103, the UE 100 establishes a connection (an RRC connection) with the HeNB 400, resulting in a state where a connection with the MME 300 in an upper layer is established (Attach).

In step S104, on the basis of the operating status of the HeNB GW 500-1, the MME 300 determines switching from the HeNB GW 500-1 to the HeNB GW 500-2. For example, upon measuring the communication characteristic in the communication using the first communication path, and detecting a problem in the HeNB GW 500-1 on the basis of the measurement result, the MME 300 determines the switching.

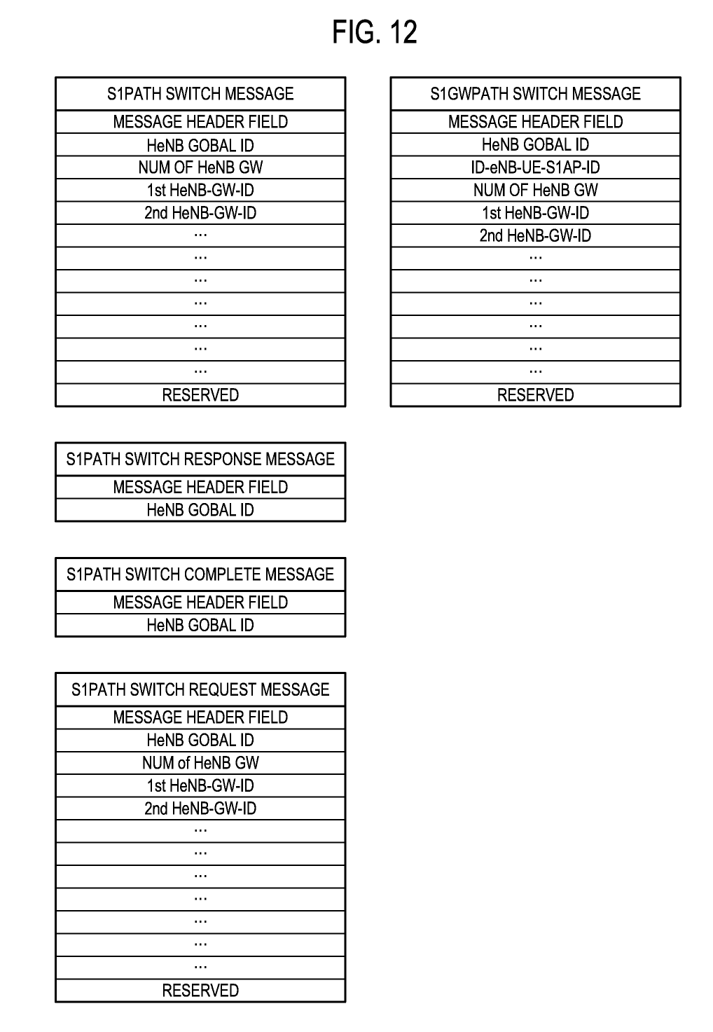

In step S105, the MME 300 transmits an S1GW Path Switch message (see FIG. 12) for switching the S1 interface between the HeNB GW 500-1 and the MME 300 to passing through the HeNB GW 500-2, to the HeNB GW 500-1.

In step S106, the MME 300 transmits an S1GW Path Switch message (see FIG. 12) for establishing a tunneling connection between the HeNB GW 500-2 and the HeNB GW 500-1, to the HeNB GW 500-2.

In step S107, the HeNB GW 500-1 transmits an S1GW Path Switch Complete message (see FIG. 12) indicating the completion of a connection (connection through the S1 interface) to the MME 300 passing through the HeNB GW 500-2, to the MME 300.

In step S108, the HeNB GW 500-2 transmits an S1GW Path Switch Complete message (see FIG. 12) indicating the completion of establishment of a tunneling connection between the HeNB GW 500-2 and the HeNB GW 500-1, to the MME 300.

Thus, the transitional communication path is established (step S109). It must be noted that the Attached state of the UE 100 is maintained. Hereinafter, an operation of establishing a second communication path is described.

In step S110, the MME 300 transmits an S1 Path Switch message (see FIG. 12) for switching the S1 interface from the HeNB GW 500-1 to the HeNB GW 500-2, to the HeNB 400. In response to the S1 Path Switch message from the MME 300, the HeNB 400 switches the S1 interface from the HeNB GW 500-1 to the HeNB GW 500-2.

Thus, the second communication path is established (step S111).

In step S112, the HeNB 400 transmits an S1GW Path Switch Response message indicating the completion of switching of the S1 interface to the HeNB GW 500-2, to the MME 300.

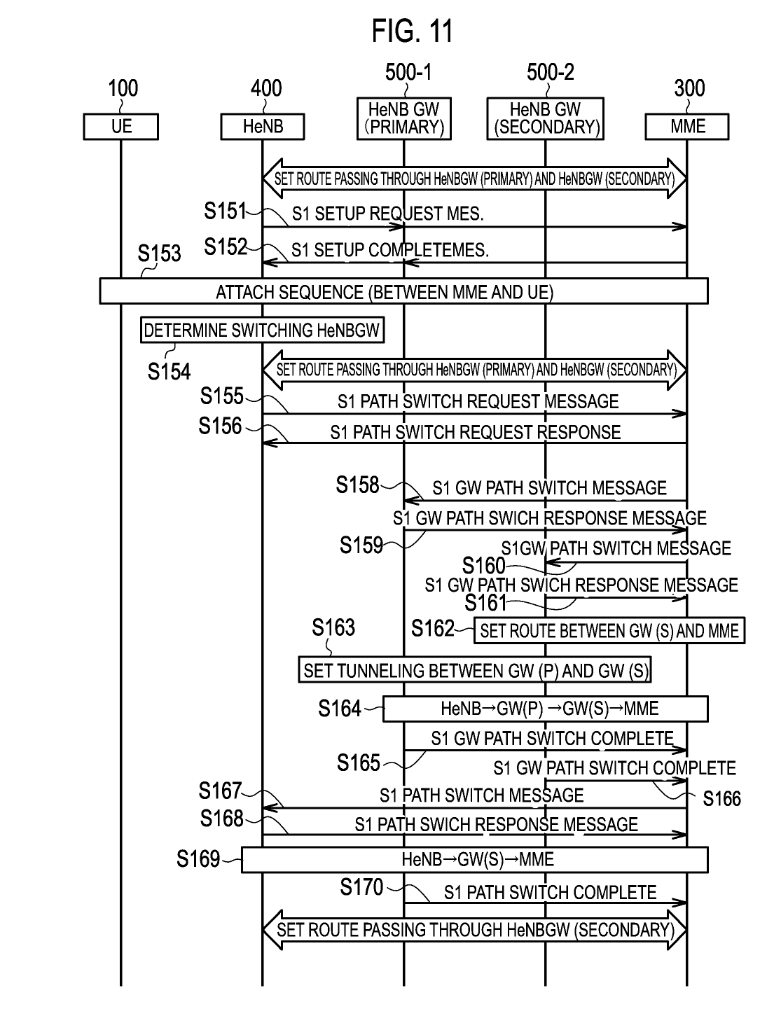

FIG. 11 is a sequence diagram of the specific example 2 of the operation pattern 1. The sequence illustrates the operation of establishing the first communication path through the operation of establishing the second communication path.

As illustrated in FIG. 11, the operation related to the establishment of the first communication path (step S151 to step S153) is the same as the specific example 1 of the operation pattern 1, and therefore, the operation after the establishment of the first communication path is described.

In step S154, on the basis of the operating status of the HeNB GW 500-1, the HeNB 400 determines switching from the HeNB GW 500-1 to the HeNB GW 500-2. For example, upon measuring the communication characteristic in the communication using the first communication path, and detecting a problem in the HeNB GW 500-1 on the basis of the measurement result, the HeNB 400 determines the switching.

In step S155, the HeNB 400 transmits an S1 Path Switch message (see FIG. 12) to prompt the switching the HeNB GW 500-1, to the MME 300.

In step S156, in response to the S1 Path Switch Request message from the HeNB 400, the MME 300 transmits an S1 Path Switch Request Response message for notifying the switching-destination, HeNB GW 500-2, to the HeNB 400.

In step S158, in response to the S1 Path Switch message, the MME 300 transmits, to the HeNB GW 500-1, an S1GW Path Switch message (see FIG. 12) for switching the S1 interface between the HeNB GW 500-1 and the MME 300 to passing through the HeNB GW 500-2. In response to the S1GW Path Switch message from the MME 300, the HeNB GW 500-1 starts a connection (connection through the S1 interface) to the MME 300 passing through the HeNB GW 500-2, and transmits an S1GW Path Switch Response message, which is a response to the S1GW Path Switch message, to the MME 300 (step S159).

In step S160, the MME 300 transmits an S1GW Path Switch message (see FIG. 12) for establishing a tunneling connection between the HeNB GW 500-2 and the HeNB GW 500-1, to the HeNB GW 500-2. In response to the S1GW Path Switch message from the MME 300, the HeNB GW 500-2 starts the process of establishing a tunneling connection between the HeNB GW 500-2 and the HeNB GW 500-1 and at the same time, transmits an S1GW Path Switch Response message, which is a response to the S1GW Path Switch message, to the MME 300 (step S161).

Accordingly, a tunneling connection is established between the HeNB GW 500-1 and the HeNB GW 500-2 (step S163), and at the same time, a path is established between the HeNB GW 500-2 and the MME 300 (step S162). Moreover, an S1 interface passing through the HeNB GW 500-2 is established between the HeNB GW 500-1 and the MME 300 (step S164).

In step S165, the HeNB GW 500-1 transmits an S1GW Path Switch Complete message indicating the completion of a connection (connection through the S1 interface) to the MME 300 passing through the HeNB GW 500-2, to the MME 300.

In step S166, the HeNB GW 500-2 transmits an S1GW Path Switch Complete message indicating the completion of establishment of a tunneling connection between the HeNB GW 500-2 and the HeNB GW 500-1, to the MME 300.

Thus, the transitional communication path is established. It must be noted that the Attached state of the UE 100 is maintained. Hereinafter, an operation of establishing a second communication path is described.

In step S167, the MME 300 transmits an S1 Path Switch message (see FIG. 12) for switching the S1 interface from the HeNB GW 500-1 to the HeNB GW 500-2, to the HeNB 400. In response to the S1 Path Switch message from the MME 300, the HeNB 400 starts the process of switching the S1 interface from the HeNB GW 500-1 to the HeNB GW 500-2, and at the same time, transmits an S1 Path Switch Response message (see FIG. 12), which is a response to the S1 Path Switch message, to the MME 300 (step S168).

Thus, the second communication path is established (step S169).

In step S170, the HeNB 400 transmits an S1GW Path Switch Complete message indicating the completion of switching of the S1 interface to the HeNB GW 500-2, to the MME 300.

(3.2) Operation Pattern 2

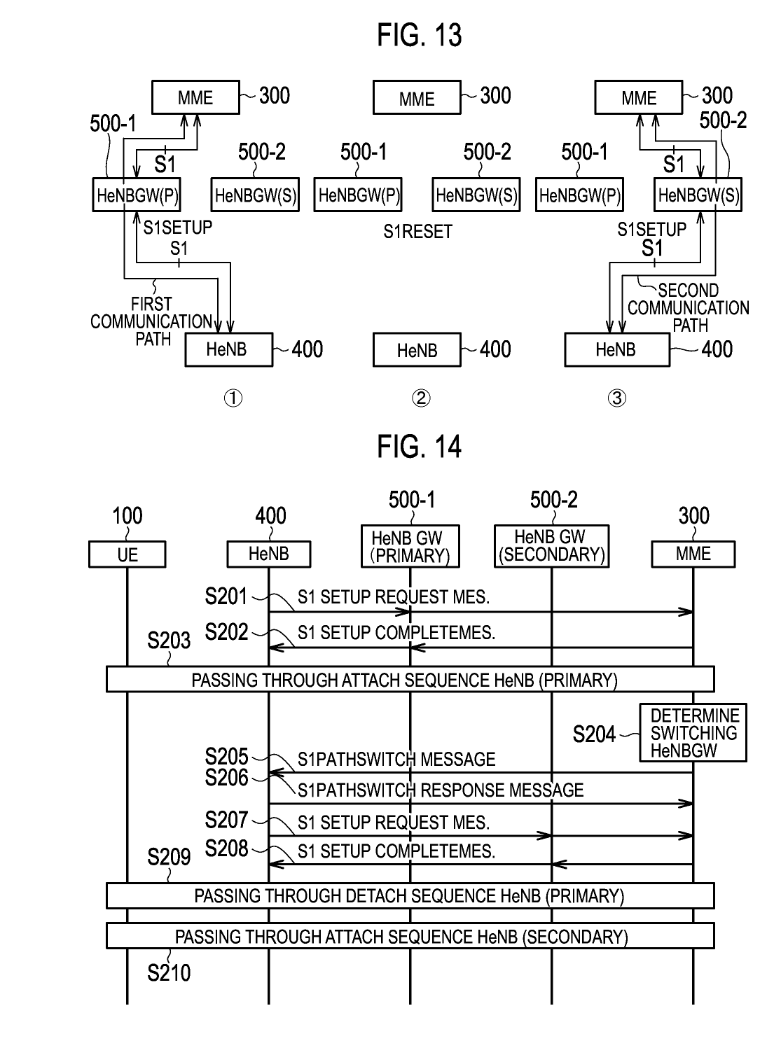

Next, an operation pattern 2 will be described. FIG. 13 is a diagram for explaining the operation pattern 2.

As illustrated in FIG. 13, firstly, a first communication path passing through the HeNB GW 500-1 is established between the MME 300 and the HeNB 400. The UE 100 that is connected to the HeNB 400 communicates with the MME 300 using the first communication path.

On the basis of the operating status of the HeNB GW 500-1, the MME 300 or the HeNB 400 determines switching from the HeNB GW 500-1 to the HeNB GW 500-2. For example, upon measuring the communication characteristic in the communication using the first communication path, and detecting a problem in the HeNB GW 500-1 on the basis of the measurement result, the MME 300 or the HeNB 400 determines the switching. If the throughput in the communication using the first communication path is lower than a threshold value, or the response time in the communication has exceeded the threshold value, it can be decided that a problem has occurred in the HeNB GW 500-1.

Once switching from the HeNB GW 500-1 to the HeNB GW 500-2 is determined, the process of switching to the HeNB GW 500-2 starts.

Secondly, the first communication path is disconnected. Accordingly, the UE 100 that is connected to the HeNB 400 is set to a state (Detach), where communication with the MME 300 is not possible.

Thirdly, a second communication path without passing through the HeNB GW 500-1, and passing through the HeNB GW 500-2 is established between the MME 300 and the HeNB 400.

Thus, in the operation pattern 2, the first communication path is disconnected before establishing the second communication path. Accordingly, switching from the HeNB GW 500-1 to the HeNB GW 500-2 can be performed by a simple method.

Next, specific examples 1 and 2 of the operation pattern 2 will be described. In the specific example 1, switching from the HeNB GW 500-1 to the HeNB GW 500-2 is led by the MME 300. In contrast, in the specific example 2, the switching is led by the HeNB 400.

FIG. 14 is a sequence diagram of the specific example 1 of the operation pattern 2. The sequence illustrates the operation of establishing the first communication path through the operation of establishing the second communication path.

As illustrated in FIG. 14, the operation related to the establishment of the first communication path (step S201 to step S203) is the same as the operation pattern 1, and therefore, the operation after the establishment of the first communication path is described.

In step S204, on the basis of the operating status of the HeNB GW 500-1, the MME 300 determines switching from the HeNB

GW 500-1 to the HeNB GW 500-2. For example, upon measuring the communication characteristic in the communication using the first communication path, and detecting a problem in the HeNB GW 500-1 on the basis of the measurement result, the MME 300 determines the switching.

In step S205, the MME 300 transmits an S1 Path Switch message (see FIG. 12) for notifying the switching destination HeNB GW 500-2, to the HeNB 400. It must be noted that the S1 Path Switch message may include the information about a plurality of HeNB GWs 500 as the candidates of the switching destination. In response to the S1 Path Switch message from the MME 300, the HeNB 400 starts the process of switching the S1 interface from the HeNB GW 500-1 to the HeNB GW 500-2, and at the same time, transmits an S1 Path Switch Response message (see FIG. 12), which is a response to the S1 Path Switch message, to the MME 300 (step S206).

In step S207, the HeNB 400 transmits an S1 Setup Request message for requesting the establishment of an S1 interface between the HeNB GW 500-2 and the MME 300, to the HeNB GW 500-2. In response to the S1 Setup Request message from the HeNB 400, the HeNB GW 500-1 starts the process of establishing an S1 interface between the HeNB GW 500-1 and the MME 300, and at the same time, transmits an S1 Setup Request message for requesting the establishment of an S1 interface between the MME 300 and the HeNB GW 500-2, to the MME 300.

In step S208, in response to the S1 Setup Request message from the HeNB GW 500-2, the MME 300 establishes an S1 interface between the MME 300 and the HeNB GW 500-2, and transmits an S1 Setup Complete message indicating the completion of establishment of the S1 interface, to the HeNB GW 500-2. Furthermore, the HeNB GW 500-2 transmits an S1 Setup Complete message indicating the completion of establishment of the S1 interface between the MME 300 and the HeNB GW 500-2, to the HeNB 400.

It must be noted that the UE 100 that is connected to the HeNB 400 is now set to the Detached state (step S209).Following this, the UE 100 again establishes a connection with the MME 300, and is set to a state where the communication with the MME 300 is not possible (step S210).

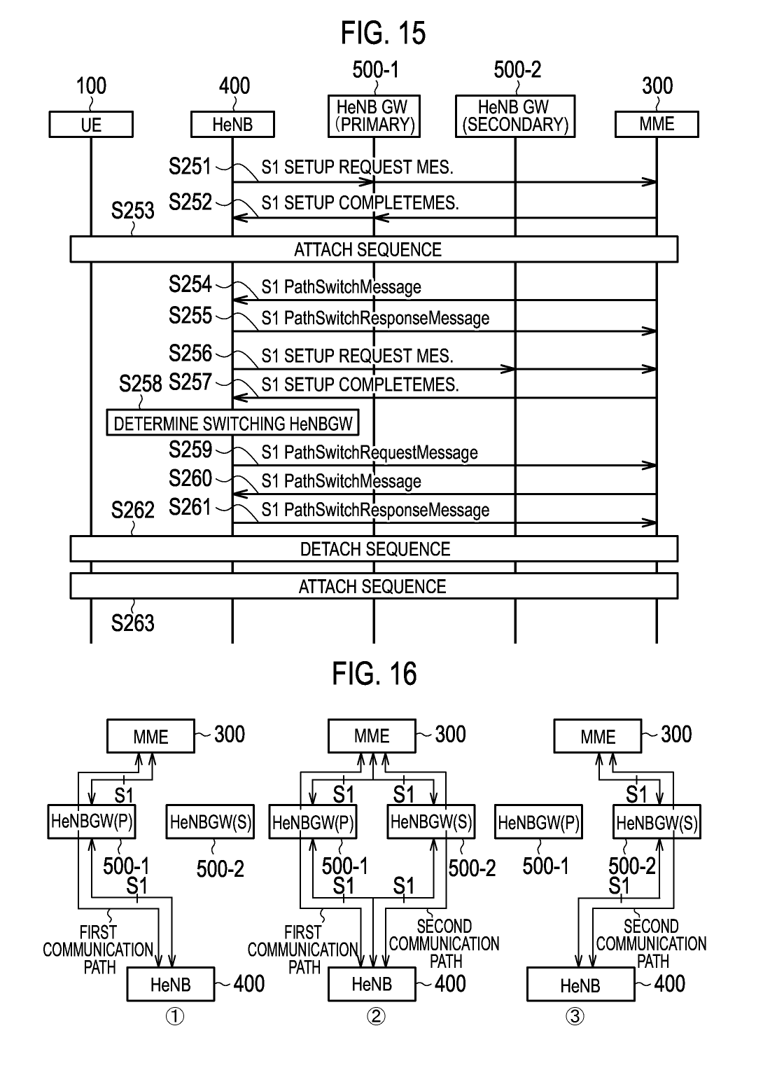

FIG. 15 is a sequence diagram of the specific example 2 of the operation pattern 2. The sequence illustrates the operation of establishing the first communication path through the operation of establishing the second communication path.

As illustrated in FIG. 15, the operation related to the establishment of the first communication path (step S251 to step S253) is the same as the operation pattern 1, and therefore, the operation after the establishment of the first communication path is described.

In step S254, the MME 300 transmits an S1 Path Switch message (see FIG. 12) for notifying the switching destination, HeNB GW 500-2, to the HeNB 400.

In step S255, the HeNB 400 transmits an S1 Path Switch Response message (see FIG. 12), which is a response to the S1 Path Switch message, to the MME 300.

In step S256, the HeNB 400 transmits an S1 Setup Request message for requesting the establishment of an S1 interface between the HeNB GW 500-2 and the MME 300, to the HeNB GW 500-2. In response to the S1 Setup Request message from the HeNB 400, the HeNB GW 500-1 starts the process of establishing an S1 interface between the HeNB GW 500-1 and the MME 300, and at the same time, transmits an S1 Setup Request message for requesting the establishment of an S1 interface between the MME 300 and the HeNB GW 500-2, to the MME 300.

In step S257, in response to the S1 Setup Request message from the HeNB GW 500-2, the MME 300 establishes an S1 interface between the MME 300 and the HeNB GW 500-2, and transmits an S1 Setup Complete message indicating the completion of establishment of the S1 interface, to the HeNB GW 500-2. Furthermore, the HeNB GW 500-2 transmits an S1 Setup Complete message indicating the completion of establishment of the S1 interface between the MME 300 and the HeNB GW 500-2, to the HeNB 400.

In step S258, on the basis of the operating status of the HeNB GW 500-1, the HeNB 400 determines switching from the HeNB GW 500-1 to the HeNB GW 500-2. For example, upon measuring the communication characteristic in the communication using the first communication path, and detecting a problem in the HeNB GW 500-1 on the basis of the measurement result, the MME 300 determines the switching.

In step S259, the HeNB 400 transmits an S1 Path Switch message (see FIG. 12) for requesting the switching to the HeNB GW 500-2, to the MME 300.

In step S260, in response to the S1 Path Switch Request message from the HeNB 400, the MME 300 transmits an S1 Path Switch message (see FIG. 12) for switching the S1 interface to the HeNB GW 500-2, to the HeNB 400.

In step S261, the HeNB 400 transmits an S1 Path Switch Response message (see FIG. 12), which is a response to the S1 Path Switch Request message, to the MME 300.

It must be noted that the UE 100 that is connected to the HeNB 400 is now set to the Detached state (step S262). Following this, the UE 100 again establishes a connection with the MME 300, and is set to a state where the communication with the MME 300 is not possible (step S263).

(3.3) Operation Pattern 3

Next, an operation pattern 3 will be described. FIG. 16 is a diagram for explaining the operation pattern 3. In the operation pattern 3, the procedure in the operation pattern 2 is changed partially.

As illustrated in FIG. 16, firstly, a first communication path passing through the HeNB GW 500-1 is established between the MME 300 and the HeNB 400. The UE 100 that is connected to the HeNB 400 communicates with the MME 300 using the first communication path.

On the basis of the operating status of the HeNB GW 500-1, the MME 300 or the HeNB 400 determines switching from the HeNB GW 500-1 to the HeNB GW 500-2. For example, upon measuring the communication characteristic in the communication using the first communication path, and detecting a problem in the HeNB GW 500-1 on the basis of the measurement result, the MME 300 or the HeNB 400 determines the switching. If the throughput in the communication using the first communication path is lower than a threshold value, or the response time in the communication has exceeded the threshold value, it can be decided that a problem has occurred in the HeNB GW 500-1.

Once switching from the HeNB GW 500-1 to the HeNB GW 500-2 is determined, the process of switching to the HeNB GW 500-2 starts.

Secondly, the second communication path is established when the first communication path has been established. Accordingly, the UE 100 that is connected to the HeNB 400 is in a state where communication with the MME 300 can be continued.

Thirdly, the first communication path is disconnected after the second communication path is established.

Thus, in the operation pattern 3, the first communication path is disconnected after the second communication path is established. Accordingly, switching from the HeNB GW 500-1 to the HeNB GW 500-2 can be performed without interrupting the communication path between the HeNB 400 and the MME 300.

(4) Conclusion of Embodiment

As described above, according to the communication control method applicable in the mobile communication system provided with the HeNB GW 500-1, which manages the HeNB 400, on the first communication path between the MME 300 and the

HeNB 400, in the case of switching to the HeNB GW 500-2 for managing the HeNB 400 in place of the HeNB GW 500-1, the second communication path without passing through the HeNB GW 500-1 and passing through the HeNB GW 500-2 is established between the MME 300 and the HeNB 400.

Thus, in a case where it is preferred to stop the HeNB GW 500-1 due to reasons such as a problem or failure in the HeNB GW 500-1, a second communication path without passing through the HeNB GW 500-1 and passing through the HeNB GW 500-2 is established between the MME 300 and the HeNB 400 because of which the HeNB GW 500-2 can manage the HeNB 400 in place of the HeNB GW 500-1. Therefore, it is possible to appropriately handle a case where the HeNB GW 500-1 is to be stopped.

In the operation pattern 1 through the operation pattern 3, the MME 300 or the HeNB 400 determines switching from the HeNB GW 500-1 to the HeNB GW 500-2 on the basis of the operating status of the HeNB GW 500-1. Accordingly, the switching from the HeNB GW 500-1 to the HeNB GW 500-2 can be determined automatically without any efforts.

In the operation pattern 1, after establishing the transitional communication path passing through both the HeNB GW 500-1 and the HeNB GW 500-2 while maintaining a part of the first communication path, the second communication path is established while maintaining a part of the transitional communication path. Accordingly, switching from the HeNB GW 500-1 to the HeNB GW 500-2 can be performed without interrupting the communication path between the HeNB 400 and the MME 300.

In the operation pattern 2, the first communication path is disconnected before establishing the second communication path. Accordingly, switching from the HeNB GW 500-1 to the HeNB GW 500-2 can be performed by a simple method.

In the operation pattern 3, the first communication path is disconnected after the second communication path is established. Accordingly, switching from the HeNB GW 500-1 to the HeNB GW 500-2 can be performed without interrupting the communication path between the HeNB 400 and the MME 300.

### Other Embodiments

Thus, the present invention has been described with the embodiment. However, it should not be understood that those descriptions and drawings constituting a part of the present disclosure limit the present invention.

The above-described operation pattern 1 through operation pattern 3 can be used properly depending on the status. For example, when the UE 100 that is connected to the HeNB 400 does not exist, the operation pattern 2 that is a simple method may be selected, and when the UE 100 that is connected to the HeNB 400 exists, either the operation pattern 1 or the operation pattern 3 may be selected to maintain the connection.

Furthermore, each of the above-described operation sequences may be mutually combined and executed.

In the above embodiment, mainly the switching from the HeNB GW 500-1 to the HeNB GW 500-2 was explained, however, after the switching, when the operation of the HeNB GW 500-1 is restarted, switching from the HeNB GW 500-2 to the HeNB GW 500-1 can also be performed. A procedure same as that in the above operation pattern 1 to the operation pattern 3 can be applied to the switching from the HeNB GW 500-2 to the HeNB GW 500-1.

The entire contents of U.S. Provisional Application No. 61/611987 (filed on Mar. 16, 2012) are incorporated herein by reference.

### INDUSTRIAL APPLICABILITY

As described, the present invention is useful in mobile communication fields.

1. A communication control method applied to a mobile communication system, comprising:
a switching step of switching, from a first gateway device which is located on a first communication path between a core network device and a home base station and which manages the home base station, to a second gateway device for managing the home base station in place of the first gateway device,
wherein the switching step comprises:
an establishment step of establishing, between the core network device and the home base station, a second communication path which passes through the second gateway device and which does not pass through the first gateway device.

2. The communication control method according to claim 1, further comprising:
a determination step of determining, by the core network device or the home base station, a switching from the first gateway device to the second gateway device, on the basis of an operating status of the first gateway device.

3. The communication control method according to claim 1, wherein
the establishment step comprises:
a step of establishing a transitional communication path which passes through both the first gateway device and the second gateway device, while maintaining a part of the first communication path; and
a step of establishing the second communication path, while maintaining a part of the transitional communication path.

4. The communication control method according to claim 1, wherein
the switching step comprises:
a disconnection step of disconnecting the first communication path, before establishing the second communication path in the establishment step.

5. The communication control method according to claim 1, wherein
the switching step comprises:
a disconnection step of disconnecting the first communication path, after establishing the second communication path in the establishment step.

6. A home base station applied to a mobile communication system, comprising:
a communication unit that communicates with a core network device using a first communication path which passes through a first gateway device; and
a control unit that controls to establish, between the core network device and the home base station, a second communication path which passes through a second gateway device and which does not pass through the first gateway device, in a case of switching to the second gateway device for managing the home base station in place of the first gateway device.

7. A core network device applied to a mobile communication system, comprising:
a communication unit that communicates with a home base station using a first communication path which passes through a first gateway device; and
a control unit that controls to establish, between the core network device and the home base station, a second communication path which passes through a second gateway device and which does not pass through the first gateway device, in a case of switching to the second gateway device for managing the home base station in place of the first gateway device.
